(19) United States
(12) Patent Application Publication
(10) Pub. No.: US 2025/0065795 A1
(43) Pub. Date: Feb. 27, 2025

(54) LEISURE VEHICLE, MODULAR ARRANGEMENT AND MODULAR CONSTRUCTION SYSTEM

(71) Applicant: Thor Tech, Inc., Elkhart, IN (US)

(72) Inventors: Alexander Kasteleiner, Greifenberg (DE); Olaf Sackers, Sulz (DE); Jens Kromer, Achern (DE)

(73) Assignee: Thor Tech, Inc., Elkhart, IN (US)

(21) Appl. No.: 18/813,860

(22) Filed: Aug. 23, 2024

(30) Foreign Application Priority Data
Aug. 25, 2023 (DE) 10 2023 122 931.1

(51) Int. Cl. B60P 3/34; B60N 3/10; B60N 3/16; B60P 3/36; B60R 15/02; B60R 16/033

(52) U.S. Cl. CPC B60P 3/34; B60N 3/104; B60N 3/16; B60P 3/36; B60R 15/02; B60R 16/033

(57) ABSTRACT

A modular arrangement for a leisure vehicle, in particular a motorhome and/or a campervan and/or a vehicle based on a high-roof station wagon recreational vehicle, with at least one kitchen module. It is proposed that a storage device is provided, that the kitchen module is connected to the storage device by means of at least one pull-out rail and that the kitchen module can be pulled out at least substantially from the storage device. Furthermore, a leisure vehicle and a modular system specified.

### BACKGROUND

The invention relates to a recreational vehicle, in particular a motorhome and/or a campervan. In particular, the invention relates to a vehicle based on a high roof combination recreational vehicle.

DE 10 2021 114 915 A1 discloses a leisure vehicle with a double door arranged on or in a side wall. Thanks to a furniture element that can be arranged at different heights, a user can open the furniture element when it is closed door leaf inside the leisure vehicle and outside the leisure vehicle when the door leaf is open. The furniture element can be a kitchen module.

DE 10 2016 200 198 A1 discloses an arrangement for stowing a kitchen module in a vehicle. The vehicle has a Vehicle wall with an outer body panel and an inner body panel. In a rest position, the kitchen module is arranged in a free space of the vehicle wall formed between the outer body panelling and the inner body panelling and through an opening formed in the inner body panelling into a functional position within the vehicle interior and back.

The arrangement known from DE 10 2016 200 198 A1 has the disadvantage that the space in the vehicle wall is very limited. The kitchen module must therefore be very small and, in particular, very flat. In addition, adaptation to the This means that a modular design in the sense of an arbitrary application in different vehicle types or vehicle models is not possible. Instead, use on a different vehicle type or vehicle model requires a completely new design.

DE 10 2021 114 479 A1 discloses a mobile kitchen unit with a mobile washing device for a recreational vehicle. The mobile washing device can have a wash basin. Furthermore, an upwardly open container and a Hybrid tank, which has a fresh water tank and a waste water tank and which is arranged in a room with a predetermined volume, is provided. Both the fresh water tank and the waste water tank have a variable volume. The container is foldable. This ensures that the washing device can be stowed or transported in a space-saving manner. The mobile kitchen unit also functions when it is not connected to the energy or water system of the recreational vehicle.

If the interior space of the recreational vehicle is particularly limited, then facilities, such as a kitchen module, cannot be realized, or only to a limited extent, if storage space for bulky goods is required at the same time. Furthermore, there are then restrictions on use, so that the kitchen module may first have to be unloaded from the recreational vehicle before it can then be used outside and independently of the recreational vehicle.

### BRIEF SUMMARY

The object of the invention is to provide a modular arrangement with a kitchen module for a recreational vehicle, a recreational vehicle and a modular construction kit system, which are of improved design. In particular, it is a task of the invention to provide a kitchen module for a recreational vehicle and a recreational vehicle in which improved use of a kitchen module is possible with a particularly limited interior space of the leisure vehicle and at the same time a storage space for the transportation of further and possibly also bulky goods is made possible.

The problem is solved by a modular arrangement with the features of independent patent claim 1, by a leisure vehicle with the features of patent claim 17 and by a modular construction kit system with the features of claim 20. Advantageous further developments of the invention are given in the subclaims.

The problem is solved by a modular arrangement for a leisure vehicle, in particular a motorhome and/or a campervan and/or a leisure vehicle based on a high-roof station wagon, with at least one kitchen module, wherein a storage device is provided, wherein the kitchen module is equipped with at least one storage device at least one pull-out rail is connected to the storage device and wherein the kitchen module can at least essentially be pulled out of the storage device.

Furthermore, the task is performed by a leisure vehicle, in particular a motorhome and/or a campervan and/or a recreational vehicle based on a high-roof station wagon, with at least one such modular arrangement.

In addition, the task is solved by a modular system for the production of modular arrangements that are suitable for recreational vehicles, especially motorhomes and/or camper vans and/or recreational vehicles based on high-roof station wagons, wherein at least two different modular arrangements can be produced for at least two different base vehicles on which the recreational vehicles are based, and wherein at least two kitchen modules can be produced by combining a kitchen module with a storage module and a storage module with a storage space module. Kitchen module without storage module is used.

It is advantageous that the kitchen module has an induction hob. This means that only a small amount of residual heat is generated on the hob. This means that, unlike a glass cooktop or a steel hob, for example, the kitchen module can be returned to its original state can be inserted into the storage device without the risk of fire. Furthermore, cooking with electrical energy is made possible. The induction hob also saves space, as the cooking pot can remain on the hob after being switched off without heated food burning.

It is advantageous that the kitchen module has a fresh water tank, that a filling cup is provided which can be mounted on an inlet for the fresh water tank when the kitchen module is extended, and that a water tap is provided via which fresh water can be supplied from the fresh water tank. For example, an electric feed pump can be provided, which is activated when the tap is operated is activated.

It is advantageous that a water tap is provided which can be folded down so that it is oriented at least approximately parallel to an upper side of the kitchen module. This allows the tap to be positioned under the storage surface when installed be pushed.

It is advantageous that the kitchen module has a sink, that a waste water outlet is provided to which a waste water hose can be fitted when the kitchen module is pulled out, and that waste water from the sink can be at least can be led directly to the waste water outlet. This allows the rinsing water to be drained in an advantageous manner. A valve can be provided that opens, for example, when the waste water hose is connected to the waste water outlet.

It is advantageous that the kitchen module has an opening on its upper side into which the sink can be inserted, that the sink can be removed and/or folded and that a cutting board can be inserted into the opening instead of the sink. The foldable sink can thus be stored compactly to create space for the chopping board. The sink can also be folded downwards so that liquid can be from the cutting board is caught by the folded sink.

It is advantageous that the kitchen module has at least one elastic band on at least one side wall and/or that the kitchen module has at least one handle, in particular a recessed grip, on at least one side wall, on which the kitchen module can be attached kitchen module can be pulled out of the storage unit. This simplifies operation.

It is advantageous that the kitchen module has an elastic side door, in particular a felt door, on at least one side wall. This allows a bendable side door can be realized, which enables advantageous access.

It is advantageous that the side door is held closed by at least one magnetic catch. This simplifies handling, as tolerances can occur when closing a felt door in particular.

It is advantageous that the storage device has a storage surface, that a worktop is provided which can be arranged under the storage surface, and that the worktop can be pulled out and is preferably extendable and removable. This means that even when the storage surface is occupied, additional space for preparing food can be created for storing dishes or for other purposes.

It is advantageous that the storage device has a storage surface and that the storage surface can be folded up so that the kitchen module can be used when the kitchen module is inserted into the storage device. This

The kitchen module can be used while seated in the rear compartment, for example. This allows hot drinks in particular to be prepared or food to be heated up.

It is advantageous that an energy source, in particular a rechargeable battery,
which, when mounted, can be arranged in a fixed position on and/or in the storage device, and that a flexible power channel is provided which connects the kitchen module to the energy source. The energy source can be designed as a transportable energy source. This means that charging can also take place outside the leisure vehicle.

It is advantageous that a storage space module is provided, which is arranged next to the kitchen module, and that the kitchen module and the storage space module together can be at least substantially pulled out of the storage device. This enables modular expansion. In particular, this allows

The rear of the vehicle can also be used to create additional functionality with larger vehicle dimensions, in particular a longer length of the rear compartment viewed in the longitudinal direction of the vehicle.

It is advantageous that an energy source, in particular a rechargeable battery, and that the energy source is arranged in the storage space module. This allows the energy source to be protected by the storage module. The energy source can be easily removed from the extended storage module.

It is advantageous that a worktop is provided, which can be pulled out from under a storage surface of the storage device, and that the kitchen module and possibly a storage module can be pulled out at least substantially from an area under the worktop when the worktop is pulled out from under the storage surface. This simultaneously results in an advantageous use of a kitchen module extended by the storage module and an advantageous use of the worktop.

It is advantageous that at least one elastic storage basket, which is preferably is at least partially formed from a felt and that the storage basket can be pulled out of the storage device. This allows a lightweight design to be achieved. The elastic design can be realized in such a way that the storage basket can be folded flat.

It is advantageous that at least one cool box is provided, which can be arranged next to the storage device. This allows a space next to the storage device to be used for the cool box.

It is advantageous that the storage device and the material inserted into the storage device inserted kitchen module are arranged in a rear compartment. This allows a rear kitchen to be realized in an advantageous way.

It is advantageous that the kitchen module can at least essentially be pulled out of the rear compartment into the open. This results in convenient access, so that that there is plenty of freedom of movement when cooking. Odors can be kept out of the interior. Waste water can be disposed of easily and directly, so that no waste water tank is required.

It is advantageous that at least two storage devices can be produced by a storage device has a side wall connected to the storage surface and a pull-out rail mounted on the side wall, and a storage device has a side wall extension connected to a side wall which is connected to a storage surface, and a pull-out rail mounted on the side wall extension. This can simplify production.

In particular, cost-effective production adapted to demand can be made possible. It is advantageous that energy sources and flexible power cable ducts are provided, whereby the modular arrangement without storage space module with a flexible

The kitchen module is connected to a power cable duct attached to the storage device, and that the modular arrangement with the storage space module has an energy source arranged in the storage space module, which is connected to the kitchen module. This enables cost-effective production adapted to demand.

Further advantages and details of the invention are explained in more detail with reference to the embodiments shown in the schematic figures.

### BRIEF DESCRIPTION OF THE SEVERAL VIEWS OF THE DRAWINGS

FIG. 1 a leisure vehicle with a modular arrangement according to a first embodiment example in a schematic, excerpt-wise, spatial representation, whereby a view from the rear with the tailgate open is shown, in which a kitchen module is inserted;

FIG. 2 an excerpted, spatial representation of the recreational vehicle of the first embodiment shown in FIG. 1, wherein the kitchen module is extended and wherein a preferred arrangement of the energy source for the first embodiment of the modular arrangement is shown;

FIG. 3 the recreational vehicle of the first embodiment shown in FIG. 1 in a schematic, excerpt-wise, spatial representation, wherein the kitchen module is extended and wherein a sink is shown in a folded state;

FIG. 4A the sink shown in FIG. 3 for the modular arrangement in a spatial representation, whereby the sink is shown in the unfolded state, in which it has a large holding volume;

FIG. 4B the sink shown in FIG. 4A in a spatial representation in the folded state;

FIG. 4C the sink shown in FIG. 4A in a spatial representation in the unfolded state, with a closure for a drain of the sink is shown;

FIG. 5 the recreational vehicle of the first embodiment shown in FIG. 3 in an excerpted, spatial representation, with a cutting board provided instead of the sink;

FIG. 6 the leisure vehicle of the first embodiment shown in FIG. 3 in an excerpted, spatial representation, with a side door shown;

FIG. 7A a magnetic catch for the modular kitchen shown in FIG. 6, which used for aside door of the kitchen module, whereby the magnetic catch is shown in the closed state;

FIG. 7B the magnetic catch for the kitchen module shown in FIG. 6, whereby the magnetic lock is shown in the open position;

FIG. 8 the leisure vehicle of the first embodiment shown in FIG. 3 in an excerpted, spatial representation, with the side door open;

FIG. 9 shows the recreational vehicle of the first embodiment shown in FIG. 3 in an excerpted, spatial representation, with a view of a rear side of the kitchen module being shown;

FIG. 10 a detailed sectional representation for the leisure vehicle shown in FIG. 9 in a schematic, partially cutaway view, illustrating an inflow and an outflow of water into and out of the kitchen module;

FIG. 11 the leisure vehicle of the first embodiment shown in FIG. 3 in an excerpt-wise, spatial representation, whereby a modified embodiment is shown in which the modular arrangement is extended by a worktop;

FIG. 12 the recreational vehicle of the first embodiment shown in FIG. 11 in an excerpt-wise, spatial representation in the modified embodiment, in which the modular arrangement is extended by a worktop, wherein the worktop is extended and wherein the kitchen module is also pulled out from under the worktop;

FIG. 13 the recreational vehicle of the first embodiment example shown in FIG. 11 in an excerpt-wise, spatial representation in the modified embodiment, in which the modular arrangement around a worktop with additional storage baskets and a cool box;

FIG. 14 a recreational vehicle with a modular arrangement according to a second embodiment example in a schematic, excerpted view, spatial representation, wherein a view from the rear with the tailgate open is shown, in which a kitchen module is inserted, and wherein a storage surface of a storage device is folded up to enable use of the kitchen module in the inserted state;

FIG. 15 shows the leisure vehicle shown in FIG. 14 in a schematic, pull-out, spatial representation, with the kitchen module pulled out of the storage device to enable the kitchen module to be used in the pulled-out state;

FIG. 16 a leisure vehicle with a modular arrangement according to a third embodiment example in a schematic, excerpt-wise, spatial representation, showing a view from the rear with the tailgate open, in which a kitchen module is inserted;

FIG. 17 the recreational vehicle shown in FIG. 16 according to the third embodiment example in a schematic, excerpt-wise, spatial representation, wherein an extended worktop is shown and wherein the kitchen module is additionally also pulled out from under the worktop to enable advantageous use of the modular arrangement; and

FIG. 18 a diagram illustrating a modular system for producing different modular arrangements, wherein, for example, a configuration of a modular arrangement according to the first embodiment example, as shown on the left-hand side, and a modular arrangement according to the third embodiment example, as shown on the right-hand side, with a large number of identical parts and only a small proportion of different or additional parts.

### DETAILED DESCRIPTION

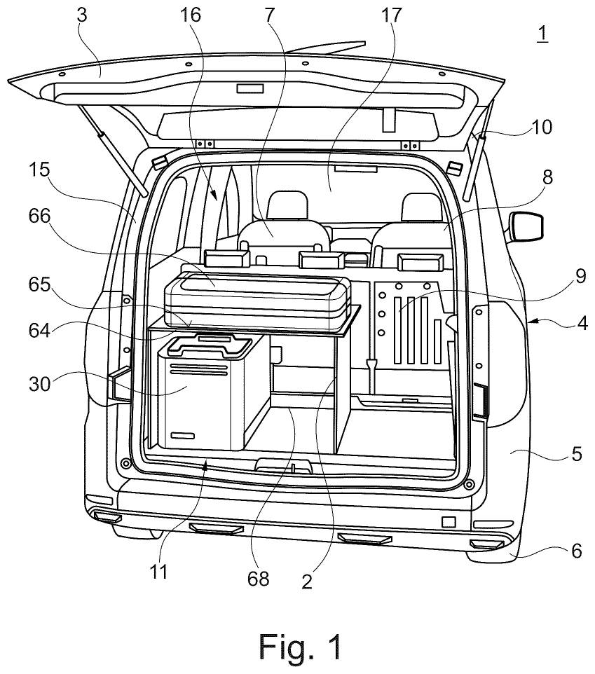

FIG. 1 shows a recreational vehicle 1 with a storage device 2 corresponding to a Schematic, spatial representation of an embodiment example, showing a view from the rear with the tailgate 3 open. The leisure vehicle 1 can be based on a base vehicle 4. In this embodiment example, the base vehicle 4 is a high-roof station wagon. This means that the leisure vehicle 1 can be produced with reduced manufacturing costs. In order to reduce the manufacturing costs the body 5, the chassis 6, the seats 7, 8 of the first row and the rear seat 9 are adopted. The tailgate 3 is preferably the tailgate 3 of the base vehicle 4.

The recreational vehicle 1 has a modular arrangement 11, which can be storage device 1. In this embodiment example, the modular arrangement is arranged in the rear 15 of the leisure vehicle 1. Here, a rear compartment 16 is realized in the rear 15 as part of an interior 17 of the leisure vehicle 1 behind the rear seat 9. In a modified embodiment, however, the rear compartment 16 can also be separate from the interior compartment 17 provided at the front.

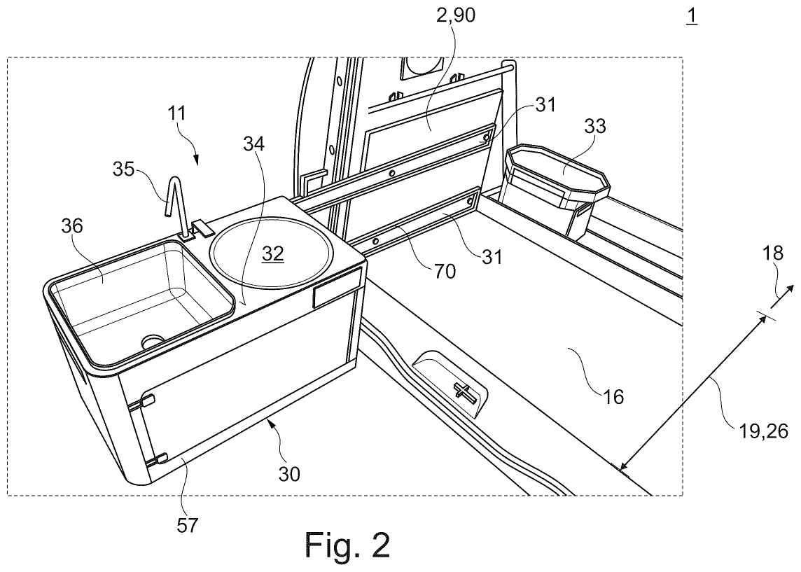

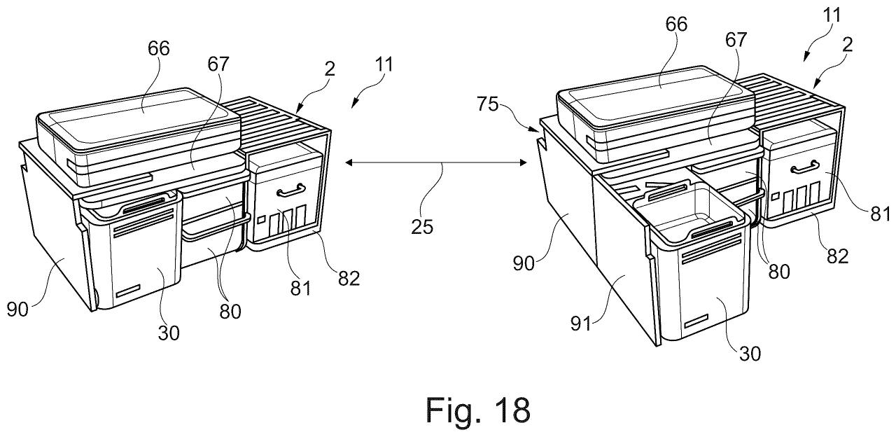

A length 19 of the rear compartment 16 considered in a longitudinal direction (longitudinal direction of the vehicle) 18 (FIG. 2) of the recreational vehicle 1, which is available for the modular arrangement 11, may depend on the type or model of the recreational vehicle 1. In particular, a normal version and a long version of a special model of a base vehicle 4, in particular a high-roof station wagon, from be produced by a vehicle manufacturer. The modular system 25 (FIG. 18) enables the design of variants of the modular arrangement 11, which can differ in particular with regard to their length 26 (FIG. 2), whereby the length 26 is preferably at least approximately equal to the length 19 of the modular arrangement 11 rear compartment 16. This is explained in more detail with reference to FIG. 18 and also with reference to the first and third embodiment examples.

Suitable modifications to the base vehicle 4 are also possible. For example, a suitable roof cut-out (not shown) can be provided on the roof 10 to enable access to a roof tent, for example.

The modular arrangement 11 has the storage device 2 and a kitchen module 30. In the leisure vehicle 1 shown in FIG. 1, the kitchen module 30 is inserted.

The configuration of the recreational vehicle 1 and the modular arrangement 11 of the first embodiment example is also described further below with reference to FIGS. 2 to 13.

FIG. 2 shows an excerpted spatial representation of the recreational vehicle 1 of the first embodiment shown in FIG. 1, with the kitchen module 30 extended.

The kitchen module 30 is connected to the storage unit 2 by means of pull-out rails 31 is connected. As illustrated in FIG. 2, the kitchen module 30 can be completely pulled out of the storage device 2. In particular, the kitchen module 30 can also be pulled out of the rear compartment 16 into the open.

The kitchen module 30 has an induction stove 32. Furthermore, a energy source 33 is provided, which is used in particular to operate the induction stove 32. In the first embodiment example of the modular arrangement 2, the energy source 33 is arranged in a fixed position with respect to the storage device 2. However, it may be possible to remove the energy source 33 for recharging.

The energy source 33 enables maximum flexibility. Self-sufficiency can also be achieved. The kitchen module 30 has an upper side 34. The induction hob 32 takes part of the upper side 34. Furthermore, a water tap 35 is mounted on the top 34. Furthermore, a sink 36 is accessible from the top 34.

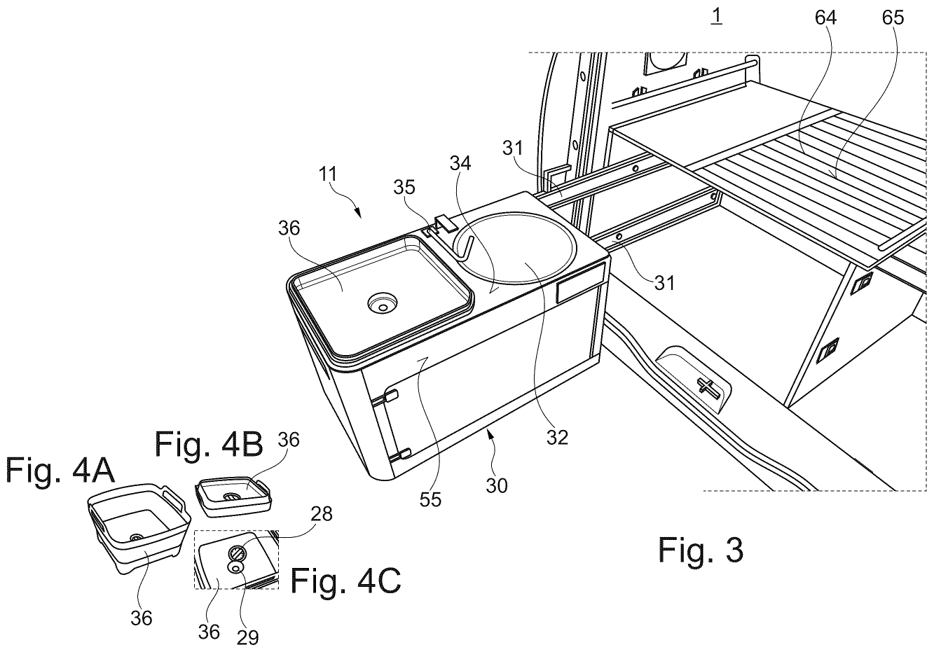

FIG. 3 shows the recreational vehicle 1 of the first embodiment example shown in FIG. 1 in a schematic, excerpt-wise, spatial representation, wherein the kitchen module 30 is pulled out. Furthermore, the sink 36 is shown in a folded state.

The foldable sink 36 can enable flexible use of storage space in the basic body (kitchen block) 57 of the kitchen module 30. The water tap 35, which is shown upright in FIG. 2, can be folded down so that it is then oriented at least approximately parallel to the upper side 34 of the kitchen module 30, as shown in FIG. 3. When the tap 35 is folded down, the kitchen module 30 can be pushed in.

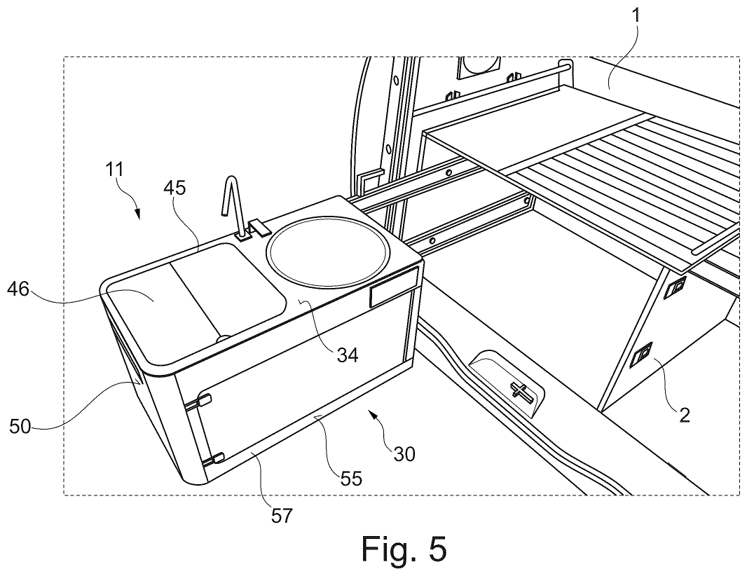

FIG. 4A shows the sink 36 shown in FIG. 3 for the modular arrangement 11 in a spatial representation, wherein the sink 36 is shown in the unfolded state, in which it has a large holding volume. FIG. 4B shows the sink 36 shown in FIG. 4A in a spatial representation in the folded state. FIG. 4C shows the sink shown in

FIG. 4A shows the sink 36 in a spatial representation in the unfolded state, wherein a closure 28 for a drain 29 of the sink 36 is shown.

FIG. 5 shows the recreational vehicle 1 of the first embodiment example shown in FIG. 3 in an excerpted, spatial representation, with a cutting board 46 in place of of the sink 36 is provided. The kitchen module 30 has an opening 45 on its upper side 34. As shown in FIG. 2, the sink 36 can be inserted into the opening 45. The sink 36 can be removed and folded up. The sink can then also be used flat, as shown in FIG. 3. As shown in FIG. 5, the cutting board 46 can be inserted into the opening 45 instead of the sink 36 can be used.

The cutting board 46 can be formed as a 2-part cutting board 46. The cutting board 46 can be formed from bamboo. The cutting board 46 can be stowed in the base body (kitchen block) 57.

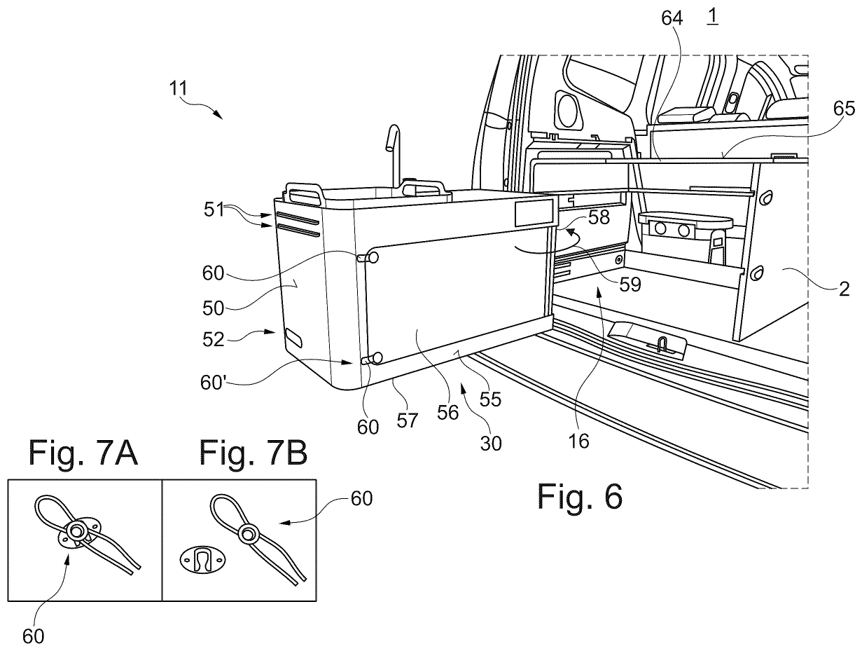

FIG. 6 shows the recreational vehicle 1 of the first embodiment example shown in FIG. 3 in an excerpt-wise, spatial representation, wherein a side door 56 of the kitchen module 30 is shown. Furthermore, FIG. 7A shows a magnetic catch 60 for the kitchen module 30 shown in FIG. 6. Such magnetic catches 60 are attached to the side door 56 of the kitchen module 30 or on a base body 57 of the kitchen module 30. FIG. 6 and FIG. 7A show the magnetic catches 60 or the magnetic catch 60 in the closed state.

FIG. 7B shows the magnetic catch 60 for the kitchen module shown in FIG. 6 in the opened state. The side door 56 can be easily closed again using such magnetic catches 60, as even large tolerances can be compensated for.

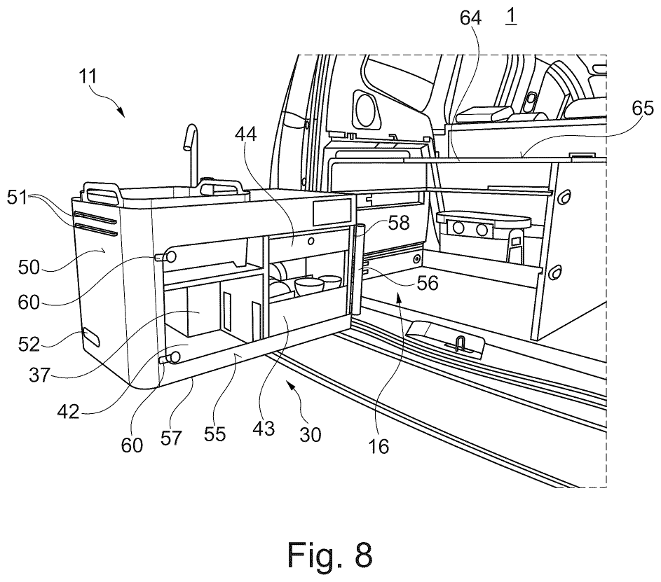

FIG. 8 shows the leisure vehicle 1 of the first embodiment example shown in FIG. 3 in an excerpt-wise, spatial representation, with the side door 56 open.

The elastic side door 56 of the kitchen module 30, which is provided on the side wall 55, is designed as a felt door 56.

The elastic side door 56 is hinged on the edge 58 facing away from the side wall 50 or the handle 52. This allows the side door 56 to be moved into the rear compartment 16 when the side door 56 is opened, as illustrated by an arrow 59 in FIG. 6.

The fresh water tank 37 shown in FIG. 8 can, for example, hold about 10 liters, in particular 12 liters. Furthermore, a large storage space 42 remains in the kitchen module 30. Furthermore, a removable storage system 43 can be provided, which can be arranged under a drawer 44, in particular a cutlery compartment 44.

As shown in FIGS. 6 and 8, the kitchen module 30 has 50 elastic bands 51. The elastic bands 51 can be in the form of rubber bands 51.

The elastic straps 51 can be used for hanging items, in particular cooking utensils. Furthermore, the kitchen module 30 has a handle 52 on the side wall 50, which is formed as a recessed grip 52. A user can use the handle to pull the kitchen module 30 out of the storage device 2.

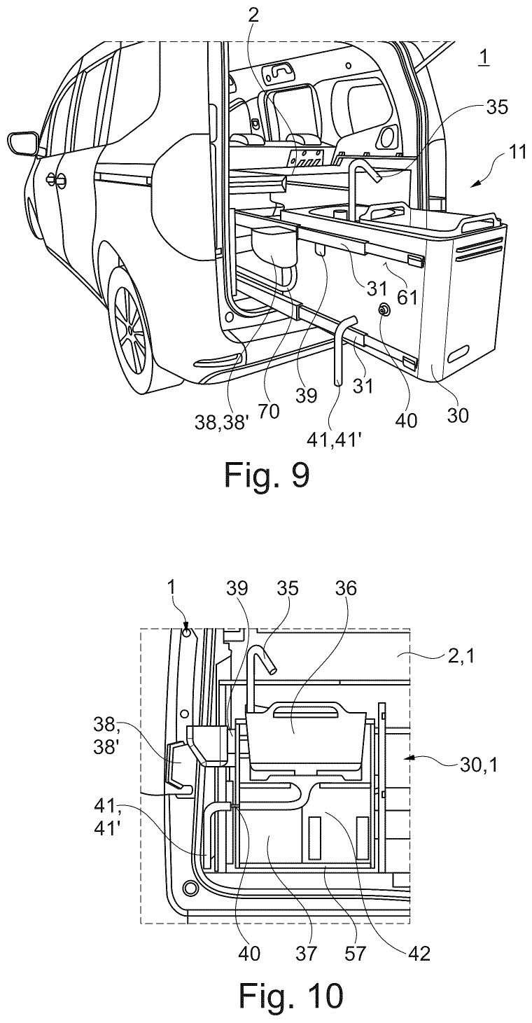

FIG. 9 shows the recreational vehicle 1 of the first embodiment example shown in FIG. 3 in a sectional, spatial representation, wherein a view of a rear side 61 of the kitchen module is shown. Furthermore, FIG. 10 shows a detailed sectional representation for the leisure vehicle 1 shown in FIG. 9 in a schematic view, partially sectioned representation, whereby an inflow and an outflow of water into and out of the kitchen module 30 are illustrated.

The kitchen module 30 also has a fresh water tank 37. Furthermore, a removable refill cup 38 is provided, which can be filled when the kitchen module 30 is extended can be fitted to an inlet 39 for the fresh water tank 37. Fresh water can then be pumped from the fresh water tank 37 via the tap 35, which can be done using an electric pump.

In this embodiment example, the filling cup 38 realizes a filling system 38′ for the fresh water. In addition, the kitchen module 30 has a waste water outlet 40, to which a removable waste water hose 41 can be fitted when the kitchen module 30 is extended. In this design example, the waste water from the sink 36 is fed directly to the waste water outlet 40. In a modified design, however, a waste water tank can also be provided. In this case, for example, emptying can take place via the waste water hose 41 using an electric pump or gravity.

The waste water hose 41 is an example of a waste water outlet. The storage device 2 has a storage plate 64 with an upper storage surface 65. One or more objects 66 (FIG. 1) can be placed on the storage surface 65. The kitchen module 30 can be used in the extended condition even if the storage surface 65 is covered with such objects.

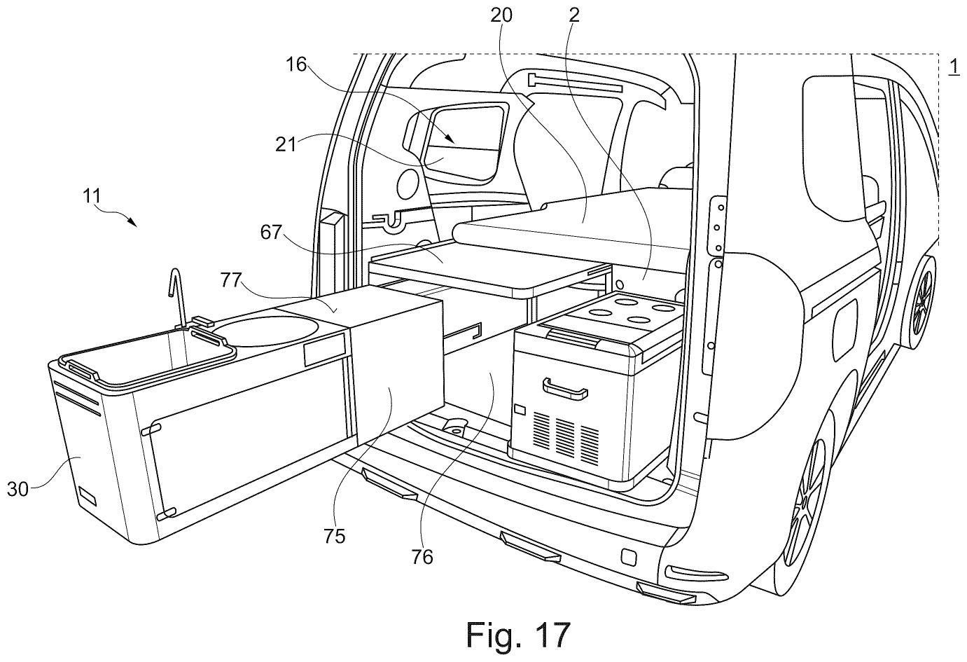

The item 33 can be a bed package comprising a comfort air mattress with a memory foam and a drop-stitch mat. An additional bed 20 (FIG. 17) can then be realized by a conversion, in which the storage surface 65 of the storage device 2 serves as a support for the drop-stitch mat.

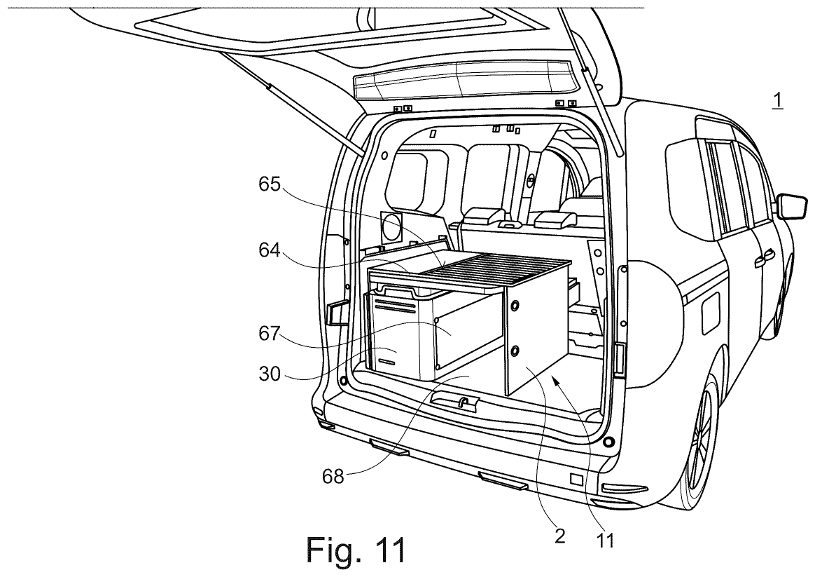

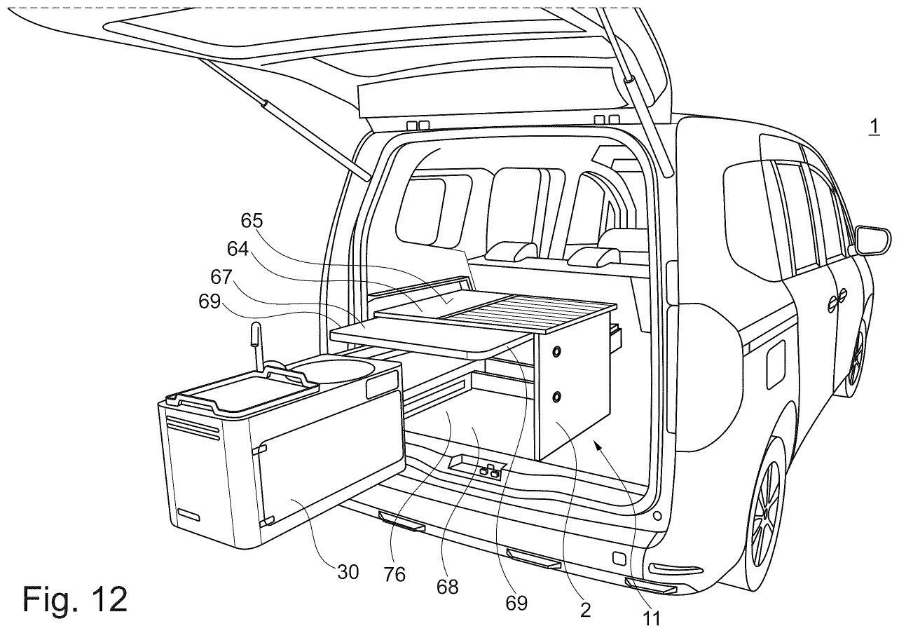

FIG. 11 shows the leisure vehicle 1 of the first embodiment shown in FIG. 3 in an excerpt-wise, spatial representation, wherein a modified embodiment is shown, in which the modular arrangement 11 is extended by a worktop 67. Furthermore, FIG. 12 shows the recreational vehicle 1 of the first embodiment example shown in FIG. 11 in an excerpt-wise, spatial representation in the modified embodiment, in which the modular arrangement 11 is extended by a worktop 67.

Worktop 67 is extended, wherein the worktop 67 is pulled out and wherein the kitchen module 30 is additionally pulled out from under the worktop 67. The worktop 67 is arranged under the shelf 65 or under the shelf 64 when the worktop 67 is pushed in. The Worktop 67 can also be pulled out, whereby it can be at least partially pulled out of the storage device 2. Preferably, the worktop 67 can be pulled out completely and is also removable. The worktop 67 can be suspended from profiles 69. The profiles are connected to the storage device 2. Here, profiles 69 can be provided as part of the modular system 25, from which the worktop 67 can be removed or not. The worktop 67 can therefore provide an extendable work surface. This provides a kitchen extension function as part of the modular system 25. In addition to the kitchen module 30, a free storage space 68 can remain in the storage unit 2.

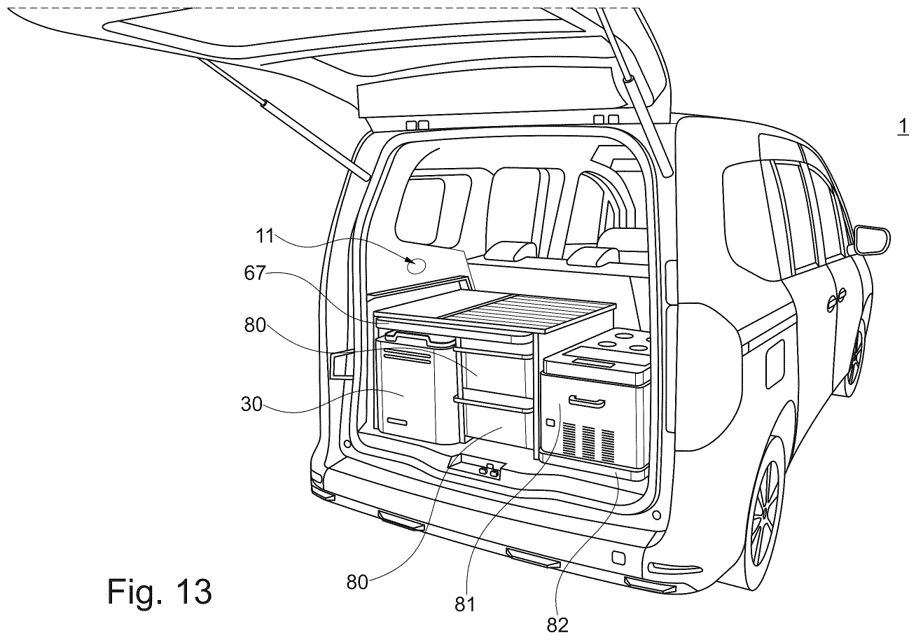

FIG. 13 shows the recreational vehicle 1 shown in FIG. 11 of the first Execution example in an excerpt-wise, spatial representation in the modified configuration, in which the modular arrangement 11 is extended by the worktop 67 and in which additional storage baskets 80 and a cool box 81 are provided.

The cool box 81 can, for example, have a capacity of about 30 liters and weigh about 13 kg, for example. Further, the cooler box 81 may be powered by the power source 33 or another such power source 33. The cool box 81 may be mounted on an extendable base 82.

At least one resilient storage basket 80 is preferably formed at least partially from a felt. The storage baskets 80 can be pulled out of the storage device 2. Furthermore, the cool box 81 is arranged next to the storage device 2.

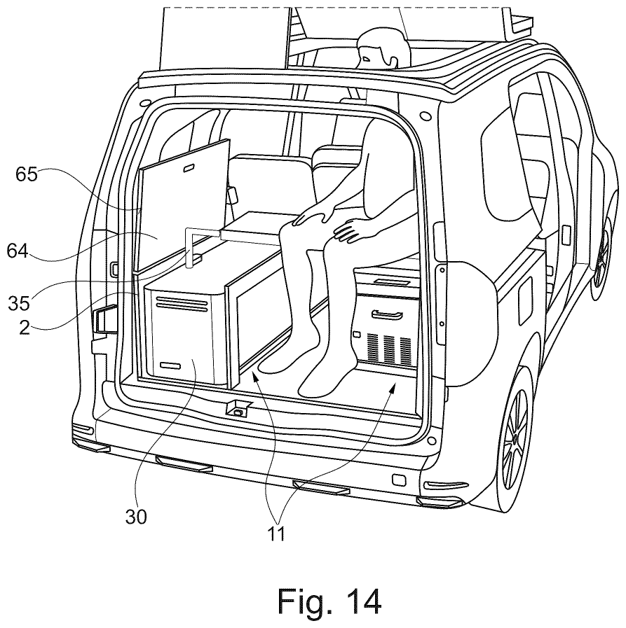

FIG. 14 shows a recreational vehicle 1 with a modular arrangement 11 corresponding to a second embodiment example in a schematic, excerpt-wise, spatial representation, whereby a view from the rear with the tailgate 3 open is shown. The kitchen module 30 is shown in the inserted state. Furthermore, the storage device 2 is designed according to the second embodiment example. The storage plate 64 with the storage surface 65 of the storage device can be can be folded up by the user. Furthermore, the water tap 35 can then be folded up. It is then possible to use the kitchen module 30 when it is inserted.

Thus, in the second embodiment example, the storage device 2 has a storage surface 65, wherein the storage surface 65 can be folded up so that the kitchen module 30 can also be used when the kitchen module 30 is inserted into the storage device 2.

In particular, it is possible to use the kitchen in the closed recreational vehicle 1 become.

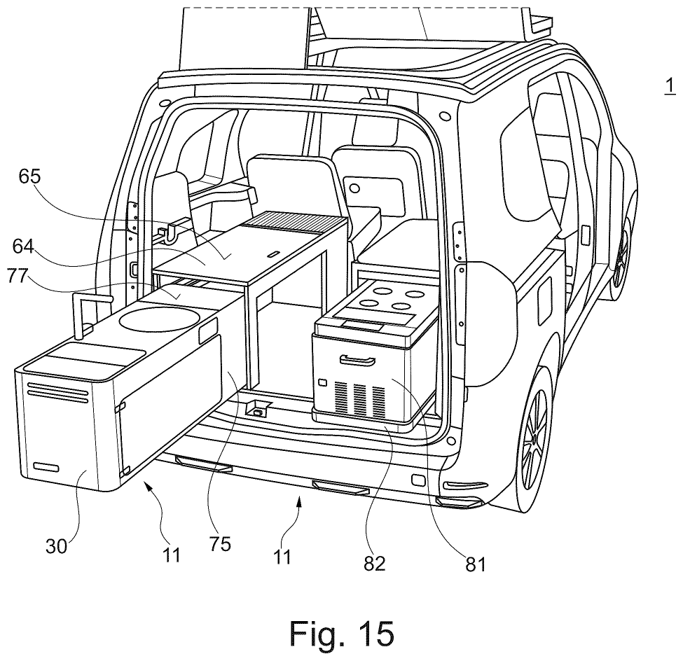

FIG. 15 shows the recreational vehicle 1 shown in FIG. 14 in a schematic, excerpt-wise, spatial representation, wherein the kitchen module 30 is pulled out of the storage device 2 in order to allow the kitchen module 30 to be used in the in the extended state. The storage plate 64 can be connected to the shelf 65 can be folded down. As a result, objects 66 (FIG. 1), for example, can remain on the storage shelf 64 and the kitchen module 30 can be used at the same time.

It is possible to use the kitchen when the leisure vehicle 1 is open. The cool box 81 is shown in FIG. 15 in a partially extended state, which is made possible by the extendable base 82.

In the first and second embodiments, the energy source 33, in particular a rechargeable battery 33, which in the assembled state is arranged in a fixed position on and/or in the storage device 2. A flexible power channel 70 is then provided, which connects the kitchen module 30 to the power source 33, as shown in FIG. 9.

However, the second embodiment example illustrates a modified embodiment in which a storage module 75 is provided, which is arranged next to the kitchen module 30, and which enables an embodiment in which the energy source 33 is arranged in the storage module 75, so that the flexible current channel 70 can be omitted. It is therefore possible, but not essential, that the energy source 33 is arranged in the storage module 75.

In a preferred embodiment, the kitchen module 30 and the storage module 75 can additionally be pulled out together at least substantially from the storage device 2. An upper side 77 of the storage module as additional storage and/or work space.

In the following, a modular arrangement 11 according to a third embodiment example and a modular building block system 25, which allows both a production of a modular arrangement 11 according to the first embodiment example and a production of a modular arrangement 11 according to the second embodiment example, are shown.

Embodiment example as well as the manufacture of a modular arrangement according to the third embodiment example.

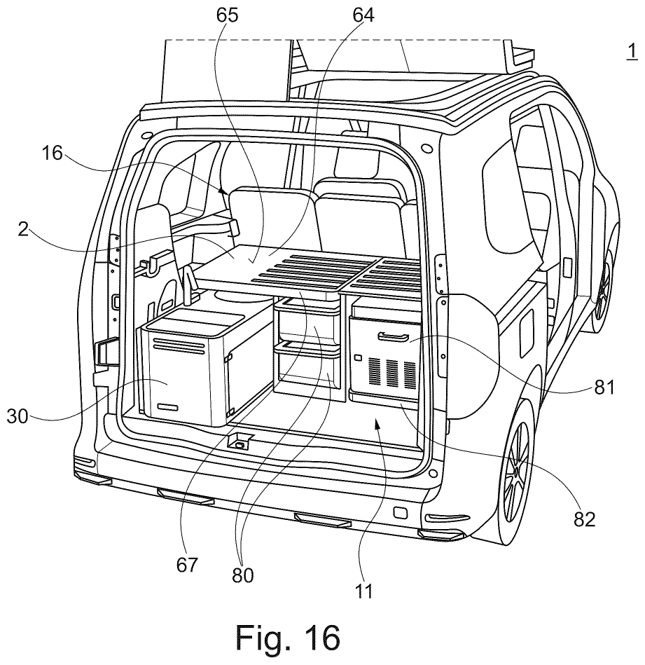

FIG. 16 shows a recreational vehicle 1 with a modular arrangement 11 according to a third embodiment example in a schematic, excerpt-wise, spatial view.

Illustration, showing a view from the rear with the tailgate 3 open, wherein the kitchen module is inserted into the storage device 2. Furthermore, FIG. 17 shows the recreational vehicle 1 shown in FIG. 16 according to the third embodiment example in a schematic, pull-out, spatial representation, wherein an extended worktop 67 is shown and wherein the kitchen module 30 is also pulled out from under the worktop 67 to enable advantageous use of the modular arrangement 11.

Thus, a worktop 67 can be mounted on the modular system 25, which can be pulled out from under a storage surface 65 of the storage device 2.

It is then further advantageous that the kitchen module 30 and the storage space module 75, if provided, can also be pulled out at least substantially from a region 76 under the worktop 67 when the worktop 67 is pulled out from under the storage surface 65. Both the worktop 67 and the upper side 77 of the storage space module 75 can then be used as additional storage and/or storage space. Serve as work surfaces.

The storage device 2 and the kitchen module 30 inserted into the storage device 2 are arranged in a rear compartment 16 of the leisure vehicle 1. The kitchen module 30 can be pulled out of the rear compartment 16 into the open air. Here for example, modular arrangements 11 with different lengths 26 can be produced to enable adaptation to different lengths 19 of the rear compartment 16 of, for example, different base vehicles 4.

In this configuration, the function can be integrated into the storage module 75 can be made. This allows the energy source 33 to be accommodated. Further storage space can also be provided. Additional drawers can also be provided. One or more water tanks or at least one larger water tank can also be provided.

Particularly in the case of a base vehicle 4, which has a greater length 19 in the rear compartment 16, the worktop 67 can be designed to be larger, in particular longer, and at the same time still be arranged completely in the rear compartment 16 when fully extended.

Furthermore, FIG. 17 illustrates that a bed 20 can remain set up when the kitchen module 30 is used. This is possible because the bed 20 only requires the storage surface 65 of the storage plate 64 of the storage device 2, which can remain occupied when the kitchen module 30 is pulled out.

Furthermore, spacious window pockets 21 can be provided on the right and left-hand sides of the vehicle, which can be used for stowing bedding, for example.

FIG. 18 shows a diagram illustrating the modular system 25 for producing different modular arrangements 11, wherein, for example, a configuration of a modular arrangement 11 according to the first embodiment example, as shown on the left-hand side, and a modular arrangement 11 according to the third embodiment example, as shown on the right-hand side, is possible. Here, a large number of identical parts can be used and it is only a small number of different or additional parts are required. The modular construction kit system 25 can be used specifically for the manufacture of modular arrangements 11 which are used for leisure vehicles 1, in particular motorhomes and/or camper vans and/or leisure vehicles based on high-roof station wagons.

By way of example, two different modular arrangements 11 are shown for two different base vehicles 4 on which the leisure vehicles 1 are based. Here, two or more kitchen modules 30 can be produced by adjusting the length of the rear compartment in relation to the respective base vehicle 4 or the respective length 19 of the rear compartment.

16 either a kitchen module 30 is combined with a storage module 75 or a kitchen module 30 is used without a storage module 75.

Furthermore, at least two depositing devices 2 can be produced in that, in one embodiment, one depositing device 2 has a side wall 90 and a pull-out rail 31 mounted on the side wall 90. In another embodiment, the storage device 2 has a side wall extension 91. The side wall extension 91 is connected to the side wall 90, whereby the side wall 90 is also connected to the storage surface 65. In addition, the pull-out rail 31 is attached to the Side wall extension 91 mounted. Here, differently designed side walls 90 can be used. Furthermore, different worktops 67 can be used.

In addition, the modular system 25 for the production of different modular arrangements 11 are provided with energy sources 33 and flexible power supply ducts 70. In one embodiment, the modular arrangement 11 can be designed without a storage module 75, but instead with a flexible electrical conduit 70. The flexible power conduit 70 then connects the kitchen module 30 to a power source 33 attached to the storage device 2

In another embodiment, the modular arrangement 11 is extended with the storage space module 75. The energy source 33 can then be arranged in the storage space module 75, so that a not necessarily flexible electrical connection of the energy source 33 to the kitchen module 30 is possible.

The invention is not limited to the embodiments described.

What is claimed is:

1. A modular arrangement for a leisure vehicle, in particular a motorhome and/or a campervan and/or a leisure vehicle based on a high-roof station wagon, with at least one kitchen module, wherein a storage device is provided, in that the kitchen module is connected to the storage device by means of at least one pull-out rail and in that the kitchen module can be at least substantially pulled out of the storage device.

2. The modular arrangement according to claim 1, wherein the kitchen module has an induction stove.

3. The modular arrangement according to claim 1, wherein, the kitchen module has a fresh water tank, in that a filling cup is provided, which can be mounted on an inlet for the fresh water tank when the kitchen module is extended, and a water tap is provided, via which fresh water can be supplied from the fresh water tank.

4. The modular arrangement according to claim 1, wherein a water tap is provided, which can be folded down in such a way that it is at least approximately parallel to an upper side of the kitchen module is oriented.

5. The modular arrangement according to claim 1, wherein the kitchen module has a sink, that a waste water outlet is provided, to which a waste water hose can be fitted when the kitchen module is extended, and that waste water from the sink can be fed at least indirectly to the waste water outlet.

6. The modular arrangement according to claim 5, wherein the kitchen module has an opening on its upper side, into which the sink can be inserted, in that the sink can be removed and/or folded up and in that a cutting board can be inserted into the opening instead of the sink.

7. The modular arrangement according to claim 1, wherein the kitchen module has at least one elastic band on at least one side wall and/or in that the kitchen module has at least one handle, in particular a recessed grip, on at least one side wall, on which the kitchen module can be removed from the storage device, or the kitchen module has at least one handle on at least one side wall can be drawn.

8. The modular arrangement according to claim 1, wherein the kitchen module has at least one side wall with a resilient side door, in particular a felt door.

9. The modular arrangement according to claim 8, wherein the side door is closed by means of at least one magnetic catch is kept closed.

10. The modular arrangement according to claim 1, wherein the storage device has a storage surface, that a worktop is provided, which can be arranged under the storage surface, and in that the worktop can be pulled out and is preferably extendable and removable.

11. The modular arrangement according to claim 1, wherein the storage device has a storage surface and in that the storage surface can be folded up so that use of the kitchen module is enabled when the kitchen module is inserted into the storage device.

12. The modular arrangement according to claim 1, wherein an energy source, in particular a rechargeable battery, is provided which, in the mounted state, is stationary on and/or in the storage device can be arranged, and that a flexible current channel is provided which connects the kitchen module to the energy source.

13. The modular arrangement according to claim 1, wherein a storage space module is provided, which is arranged next to the kitchen module, and in that the kitchen module and the storage space module can be pulled out together at least substantially from the storage device.

14. The modular arrangement according to claim 13, wherein an energy source, in particular a rechargeable battery, is provided, and in that the energy source is arranged in the storage space module.

15. The modular arrangement according to claim 1, wherein a worktop is provided, which can be pulled out from under a storage surface of the storage device, and in that the kitchen module and optionally a storage space module with the worktop pulled out from under the storage surface at least substantially from a region can be pulled out from under the worktop.

16. The modular arrangement according to claim 1, wherein:
(a) at least one elastic storage basket, which is preferably formed at least partially from a felt, is provided and in that the storage basket can be pulled out of the storage device; or
(b) at least one cooling box is provided which, in addition to the storage device can be arranged.

17. A recreational vehicle in particular motorhome and/or campervan and/or recreational vehicle based on a high-roof station wagon, comprising at least one modular arrangement according to claim 1.

18. A recreational vehicle according to claim 17, wherein the storage device and the kitchen module inserted into the storage device are arranged in a rear compartment.

19. A recreational vehicle according to claim 17, wherein the kitchen module can be pulled at least substantially out of the rear compartment into the open.

20. A modular construction kit system for the production of modular arrangements which serve for leisure vehicles, in particular motor homes and/or camper vans and/or leisure vehicles based on high-roof station wagons, wherein:
at least two different modular arrangements are used for at least two different base vehicles, on which the leisure vehicles are based, can be produced; and
at least two kitchen modules can be produced by combining a kitchen module with a storage module and using a kitchen module without a storage module.

21. The modular system according to claim 20, wherein in that at least two storage devices can be produced in that one storage device has a side wall connected to the storage surface and a pull-out rail mounted on the side wall and having a storage device having a side wall equipped with a storage surface, a side wall extension connected to the side wall extension and a pull-out rail mounted on the side wall extension.

22. The modular building block system according to claim 20, wherein energy sources and flexible power conduits are provided, the modular arrangement being designed without a storage space module with a flexible power conduit which connects the kitchen module to a power source of the storage device, and in that the modular arrangement with the storage space module has an energy source which is arranged in the storage space module and is connected to the kitchen module.
